(19) United States
(12) Patent Application Publication
(10) Pub. No.: US 2015/0296317 A1
(43) Pub. Date: Oct. 15, 2015

(54) ELECTRONIC DEVICE AND RECORDING METHOD THEREOF

(71) Applicant: Samsung Electronics Co., Ltd., Gyeonggi-do (KR)

(72) Inventors: Seong Woong PARK, Seoul (KR); Dale AHN, Seoul (KR); Yong Woo LEE, Yongin-si (KR)

(21) Appl. No.: 14/666,611

(22) Filed: Mar. 24, 2015

(30) Foreign Application Priority Data
Apr. 15, 2014 (KR) 10-2014-0045028

(51) Int. Cl. H04R 29/00; H04R 1/32; H04N 5/91; H04N 5/232; H04N 5/262

(52) U.S. Cl. CPC H04R 29/00; H04N 5/23229; H04N 5/23293; H04N 5/23212; H04N 5/2628; H04N 5/91; H04R 1/32

(57) ABSTRACT

An electronic device includes a capturing unit that captures an image and a mike unit that receives an audio signal while the image is captured. An object detection unit detects one or more objects from the image. An audio analyzing unit determines an originating position of the audio signal received by the mike unit. A mapping unit maps the audio signal to a detected object of the one or more objects that corresponds to the determined originating position.

### CLAIM OF PRIORITY

The present application claims priority under 35 U.S.C. §119(a) to Korean patent application No. 10-2014-0045028 filed Apr. 15, 2014, the disclosure of which is hereby incorporated by reference in its entirety.

### BACKGROUND

1. Field

The present disclosure relates generally to an electronic device that records contents and a recording method thereof.

2. Description of the Related Art

Digital photography and video recording has proliferated in recent years as ubiquitous electronic devices such as smartphones and tablet PCs have incorporated cameras and video recording capability. Taking photos and videos has thus becomes generalized in everyday life. Additionally, the captured photos or videos are shared more commonly through a user's social network service (SNS). When video is captured, corresponding audio is typically recorded as well.

Nevertheless, an ongoing need exists in the marketplace to enhance the user experience with today's camera devices.

### SUMMARY

Various embodiments described herein are directed to providing an electronic device that may record video contents in various manners according to characteristics of an object or an audio signal received at the time of video capture, and a recording method thereof

According to an embodiment, an electronic device includes a capturing unit that captures an image and a mike unit that receives an audio signal while the image is captured. An object detection unit detects one or more objects from the image. An audio analyzing unit determines an originating position of the audio signal received by the mike unit. A mapping unit maps the audio signal to a detected object of the one or more objects that corresponds to the determined originating position.

According to another embodiment, a recording method of an electronic device is provided. The method includes: capturing an image; receiving an audio signal while the image is captured; detecting at least one object from the image; determining an originating position of the audio signal; and mapping the audio signal to an object corresponding to the originating position.

### BRIEF DESCRIPTION OF THE DRAWINGS

FIG. 1 is a block diagram illustrating a configuration of an electronic device according to an embodiment of the present invention.

FIG. 2 is a view illustrating a display screen displaying a UI according to various embodiments of the present invention.

FIG. 3 illustrates contents recording screens according to various embodiments of the present invention.

FIG. 4 illustrates contents recording screens according to various embodiments of the present invention.

FIG. 5 illustrates contents recording screens according to various embodiments of the present invention.

FIG. 6 illustrates contents recording screens according to various embodiments of the present invention.

FIG. 7 illustrates example contents playback screens according to various embodiments of the present invention.

FIG. 8 is a block diagram illustrating an electronic device according to various embodiments of the present invention.

FIG. 9 is a flowchart illustrating a recording method of an electronic device according to an embodiment of the present invention.

### DETAILED DESCRIPTION

Hereinafter, various embodiments of the present invention are disclosed with reference to the accompanying drawings. Various modifications are possible in various embodiments of the present invention and specific embodiments are illustrated in drawings and related detailed descriptions are listed. Thus, it is intended that the present invention covers the modifications and variations of this disclosure provided they fall within the scope of the appended claims and their equivalents. With respect to the descriptions of the drawings, like reference numerals refer to like elements.

The terms “include,” “comprise,” and “have”, or “may include,” or “may comprise” and “may have” used herein indicates disclosed functions, operations, or existence of elements but does not exclude other functions, operations or elements. The meaning of “include,” “comprise,” “including,” or “comprising,” specifies a property, a region, a fixed number, a step, a process, an element and/or a component but does not exclude other properties, regions, fixed numbers, steps, processes, elements and/or components.

The meaning of the term “or” used herein includes any or all combinations of the words connected by the term “or”. For instance, the expression “A or B” may indicate include A, B, or both A and B.

The terms such as “first”, “second”, and the like used herein may refer to modifying various different elements of various embodiments, but do not limit the elements. For instance, such terms do not limit the order and/or priority of the elements. Furthermore, such terms may be used to distinguish one element from another element. For instance, both “a first user device” and “a second user device” indicate a user device but indicate different user devices from each other. For example, a first component may be referred to as a second component and vice versa without departing from the scope of the present invention.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Terms used in this specification are used to describe specific embodiments, and are not intended to limit the scope of the present invention. The terms of a singular form may include plural forms unless otherwise specified.

Otherwise indicated herein, all the terms used herein, which include technical or scientific terms, may have the same meaning that is generally understood by a person skilled in the art.

It will be further understood that terms, which are defined in the dictionary and in common use, should also be interpreted as is customary in the relevant related art and not in an idealized or overly formal sense unless expressly so defined herein.

An electronic device according to various embodiments of the present invention may have a camera function. Some examples of electronic devices according to the invention include smartphones, tablet personal computers (PCs), mobile phones, video phones, electronic book (e-book) readers, desktop personal computers (PCs), laptop personal computers (PCs), netbook computers, personal digital assistants (PDAs), portable multimedia player (PMPs), MP3 players, mobile medical devices, cameras, and wearable devices (e.g., head-mounted-devices (HMDs) such as electronic glasses, electronic apparel, electronic bracelets, electronic necklaces, electronic accessories, electronic tattoos, and smart watches).

According to some embodiments, an electronic device may be a smart home appliance having a camera function. Some examples smart home appliances include televisions, digital video disk (DVD) players, audio players, refrigerators, air conditioners, cleaners, ovens, microwave ovens, washing machines, air cleaners, set-top boxes, TV boxes (e.g., Samsung HomeSync™, Apple TV™ or Google TV™), game consoles, electronic dictionaries, electronic keys, camcorders, and electronic picture frames.

According to embodiments of the present invention, an electronic device may include at least one of various medical devices (for example, magnetic resonance angiography (MRA) devices, magnetic resonance imaging (MRI) devices, computed tomography (CT) devices, medical imaging devices, ultrasonic devices, etc.), navigation devices, global positioning system (GPS) receivers, event data recorders (EDRs), flight data recorders (FDRs), vehicle infotainment devices, marine electronic equipment (for example, marine navigation systems, gyro compasses, etc.), avionics, security equipment, car head units, industrial or household robots, financial institutions' automatic teller's machines (ATMs), and stores' point of sales (POS).

According to an embodiment of the present invention, an electronic device may be part of furniture or buildings/structures having a camera function. Other examples of electronic devices include electronic boards, electronic signature receiving devices, projectors, or various measuring instruments (for example, water, electricity, gas, or radio signal measuring instruments). An electronic device according to an embodiment of the present invention may be one of the above-mentioned various devices or a combination thereof. Additionally, an electronic device according to an embodiment of the present invention may be a flexible device. Furthermore, it is apparent to those skilled in the art that an electronic device according to an embodiment of the present invention is not limited to the above-mentioned devices.

Hereinafter, an electronic device according to various embodiments of the present invention will be described in more detail with reference to the accompanying drawings. The term “user” in various embodiments may refer to a person using an electronic device or a device using an electronic device (for example, an artificial intelligent electronic device).

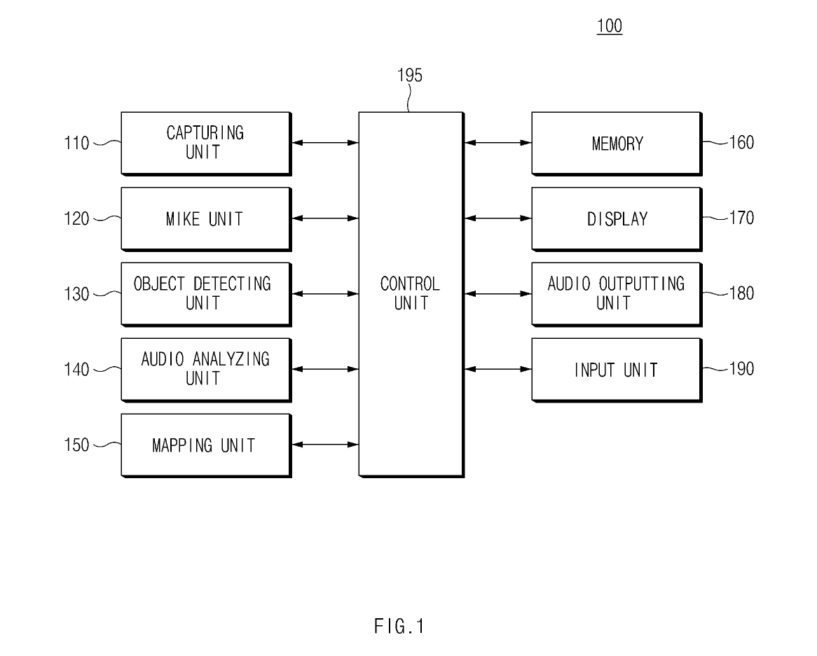

FIG. 1 is a block diagram illustrating an example configuration of an electronic device, 100, according to an embodiment of the present invention. Electronic device 100 may include a capturing unit 110, a microphone (“mike”) unit 120, an object detecting unit 130, an audio analyzing unit 140, a mapping unit 150, a memory 160, a display 170, an audio outputting unit 180, an input unit 190, and a control unit 195. The electronic device 100 may be implemented with any of various kinds of electronic devices capable of recording contents, for example, mobile phones, smartphones, PDAs, notebook PCs, Tablet PCs, cameras, video cameras, voice recorders, and CCTVs.

The capturing unit 110 may capture an image. According to an embodiment of the present invention, the capturing unit 110 may capture images continuously with time, i.e., moving images on a frame by frame basis, and may then generate video images.

According to an embodiment of the present invention, the capturing unit 110 may include a plurality of cameras. For example, when the electronic device 100 is implemented with a smartphone, the capturing unit 110 may include two cameras positioned at the front of the smartphone and two cameras positioned at the back of the smartphone. When the capturing unit 110 is implemented with a plurality of cameras, an image captured by each of a plurality of cameras may have a disparity due to a visual point difference of a capturing lens.

The mike unit 120 may collect (i.e., receive) an audio signal. Mike unit 120 may convert sound incident from the surrounding environment into electrical signals to generate an audio signal. (Herein, the term “audio signal” is used to refer to either a sound wave propagating in the air or to an electrical signal derived from such a sound wave.) Mike unit 120 may collect an audio signal corresponding to a captured image. For example, the capturing unit 110 may capture an image while the mike unit 120 collects an audio signal simultaneously. Mike unit 120 may include a plurality of mikes, arranged in an array so as to form a microphone array. Each mike in the array captures a portion of an incoming audio signal (sound wave), and the audio signal portions may be differentially compared by audio analyzing unit 140 using an acoustical-based algorithm or suitable circuitry known in the art. Using the microphone array and signal comparing technique, the direction or originating point of the incoming sound wave may be determined. By determining the sound wave direction relative to the microphones, an object within the associated images can be correlated with the sound, which enables a determination as to which object within the captured image generated the sound.

The object detecting unit 130 may detect an object from an image captured by the capturing unit 110. As used herein, an object may refer to a specific portion included in an image or a recognizable item. Examples of objects include people's faces, animals, vehicles, etc. An object may also be considered at least part of the background included in a captured image.

According to an embodiment, the object detecting unit 130 may determine the position (for example, a direction or a distance) of one or more objects included in an image. As an example, when an image is captured by a plurality of cameras, the object detecting unit 130 may generate a disparity map by using a plurality of images and may determine the direction or distance of an object by using the disparity map.

According to an embodiment, the object detecting unit 130 may continuously monitor a detected object. For example, even if the position of an object is changed in a continuously captured image by a movement of the object, the object detecting unit 130 may track the object and may then determine a position change of the object.

The audio analyzing unit 140 may classify an audio signal collected by the mike unit 120. According to an embodiment, the audio analyzing unit 140 may analyze an audio signal collected by the mike unit 120. For example, the audio analyzing unit 140 may determine the direction of an audio signal by analyzing portions of the audio signal as noted above. As another example, the audio analyzing unit 140 may determine the distance of an audio signal source by analyzing portions of the audio signal.

According to an embodiment, the audio analyzing unit 140 may classify an audio signal on the basis of an analysis result of the audio signal. For example, the audio analyzing unit 140 may classify an audio signal according to the originating position (for example, a direction or a distance of an audio signal, each object generating an audio signal, or each audio signal device).

The mapping unit 150 may map an audio signal classified by the audio analyzing unit 140 to an object detected from the object detecting unit 130. According to an embodiment, the mapping unit 150 may map a specific audio signal to a specific object in an image on the basis of the position of an object and the originating position of a classified audio signal. For example, the mapping unit 150 may map an object positioned in the same direction as the specific originating position to an audio signal collected on the basis of a corresponding originating position among classified audio signals. As another example, the mapping unit 150 may map an audio signal to an object positioned in the same direction as the originating position of the audio signal.

Mapping unit 150 may map an audio signal to an object on the basis of a position change of an object or an audio signal. For example, when there are a plurality of objects at the originating position of an audio signal, the electronic device 100 may map an object (of which position (direction or distance) change is identical to an originating position (direction or distance) change of an audio signal) among the plurality of objects to the audio signal.

Mapping unit 150 may generate mapping information of an object and a classified audio signal.

The memory 160 may store contents, which may include captured images, classified audio signals, and mapping information of objects and classified audio signals. The contents may include information on objects included in an image or information on classified audio signals. For example, the contents may include information on the position of an object or the originating position of an audio signal.

The display 170 may display an image or images captured by the capturing unit 110. Accordingly, a user may check a captured image as soon as the image is captured. When video, i.e., moving image contents, is played (reproduced), the display 170 displays frame by frame images to output the video.

When audio/video (A/V) contents are played, the audio outputting unit 180 may output an audio signal included in the A/V contents. According to an embodiment, while playing A/V contents, the audio outputting unit 180 may output at least part of classified audio signals at a sound level different from a level of a set audio signal. For example, the audio outputting unit 180 may output an audio signal mapped to an object selected by a user at a high level (for example, a specified first sound level) and may output the remaining audio signal at a lower level (e.g., a specified second sound level less than the first level). As another example, the audio outputting unit 180 may output an audio signal mapped to an object (for example, an object that is automatically enlarged and displayed in relation to an audio signal or an object enlarged and displayed in correspondence to a user zoom function application) enlarged and displayed on the display 170, at a high level and may output the remaining audio signal at a low level.

According to an embodiment, while playing A/V contents, the audio outputting unit 180 may output only an audio signal mapped to an object selected by a user or an object enlarged and displayed on the display 170 among classified audio signals.

According to an embodiment, the audio outputting unit 180 may include an audio outputting device such as an amp and a speaker or an output port delivering an audio signal through an external amp or speaker.

The input unit 190 may receive a user instruction. According to an embodiment, the input unit 190 may receive a user instruction for selecting an object from among detected objects. Input unit 190 may receive a user command for generating a user interface (UI) that displays UI elements enabling user selection of objects. Input unit 190 may include a touch screen and/or a touch pad, which operate by a user's touch input.

The control unit 195 may control overall operations of an electronic device. According to an embodiment, the control unit 195 may control each of the capturing unit 110, the mike unit 120, the object detecting unit 130, the audio analyzing unit 140, the mapping unit 150, the memory 160, the display 170, the audio outputting unit 180, the input unit 190, or the control unit 195, thereby recording contents and playing the recorded contents according to various embodiments.

According to an embodiment, the control unit 195 may determine whether the originating position of an audio signal having the largest signal level among classified audio signals is out of a capturing range. For example, the control unit 195 may determine whether the originating position of an audio signal is out of the capturing range by determining a capturing range according to the zoom-in or zoom-out of the capturing unit 110. When the originating position of the control unit 195 is out of the capturing range, by automatically executing a zoom-out function of the capturing unit 110, an object corresponding to the originating position may be controlled to be positioned within the capturing range. Additionally, the control unit 195 may control an output of a capturing angle adjustment UI or guide (for example, at least one of an image or a text for guiding a movement of an capturing angle of the capturing unit 110 toward the left, right, up, or down) relating to a object capturing corresponding to the originating position.

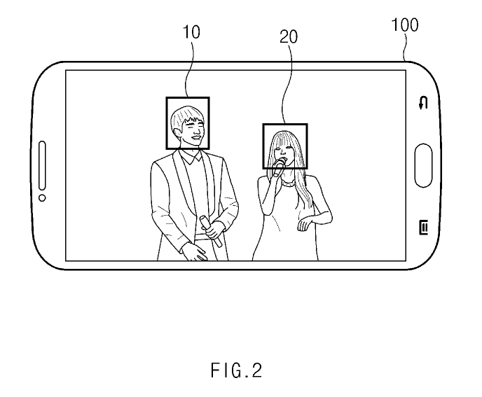

According to an embodiment, the display 170 may display a user interface (UI) representing an object included in the captured image. According to an embodiment, when playing contents, the display 170 may display a UI representing an object included in an image. This will be described with reference to FIG. 2.

FIG. 2 is a view illustrating a display screen displaying a user interface (UI) according to various embodiments of the present invention. As illustrated, a currently captured image may be displayed on a display screen of device 100. When one or more objects are detected from an image by the detection unit 130, a UI representing the detected objects may be displayed on the display screen. For instance, in the example of FIG. 2, while an image of a man and a woman singing is captured, the man's face (that is, a first object) and the woman's face (that is, a second object) may each be detected as an individual object. The display 170 may display a UI in the form of UI elements, e.g., squares 10 and 20 surrounding the man's face and the woman's face, respectively. Here, the UI elements 10, 20 are associated with the respective faces and facilitate further user actions as described below. Assuming a video clip of the scene is recorded, when the recorded contents are played back, the same UI with elements 10 and 20 may be displayed. Note that the UI may be generated in response to a predetermined first input command, e.g., a touch input on a menu (not shown), via input on a physical key, via a voice command, etc., and may be terminated responsive to another predetermined input command.

According to an embodiment, the capturing unit 110 may perform capturing by focusing or zooming-in the detected object. For example, the capturing unit 110 may capture an image by automatically focusing or zooming-in an object mapped to a signal having the largest signal level among classified audio signals. Here, zooming-in may involve performing a zoom-in function to cause an object to occupy a screen with more than a predetermined size ratio or a specified size. As another example, the capturing unit 110 may capture an image by automatically focusing or zooming-in an object mapped to an audio signal having the largest change in signal level among classified audio signals. As another example, the capturing unit 110 may capture an image by focusing or zooming-in an object selected by a user among detected objects.

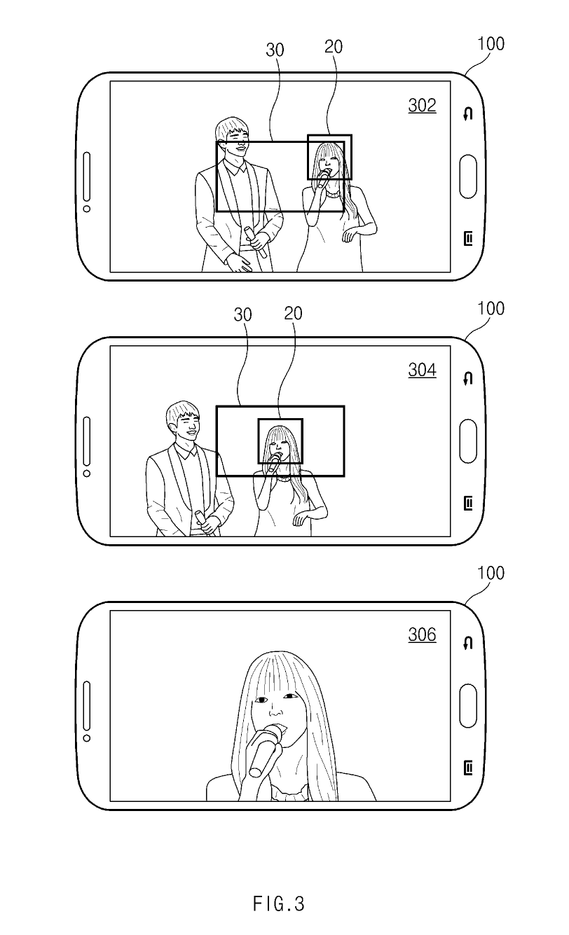

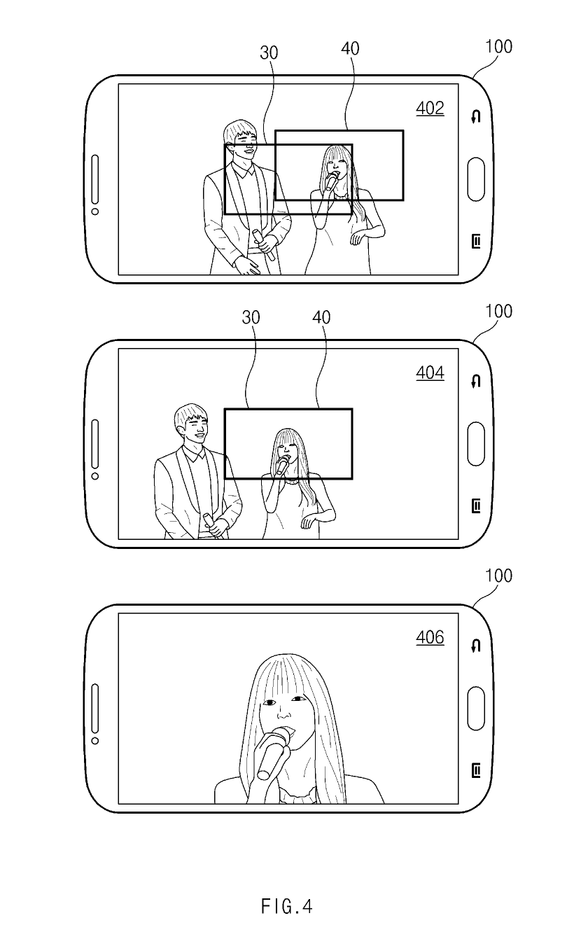

According to an embodiment of the present invention, the display 170 may display a UI prompting a user to re-position a zoomed-in object to a particular zoom-in area. This will be described with reference to FIGS. 3 and 4.

FIG. 3 illustrates examples of contents recording screens according to various embodiments of the present invention. As seen in example screen 302, a currently captured image may be displayed on a display screen. According to an embodiment of the present invention, the display 170 may display a UI including a UI element 30 representing a zoom-in area according to a current capturing direction. UI element 30 may be provided in the form of a closed geometrical shape, e.g., an outline of a box as illustrated. The displayed UI may further include a UI element 20 for an object to be zoomed-in among objects included in an image. UI element 20 may be automatically drawn around an object from which audio is currently determined to originate, or via a user-selected object. A user may change a capturing direction of the camera 110 to be positioned in a zoom-in area of an object to be zoomed-in, via a predetermined user input command with respect to the UI element 30 representing a zoom-in area. For example, when part of a second object to be zoomed-in is out of the zoom-in area 30 as shown in screen 302, a user may move a capturing direction (field of view) of a camera to the right, resulting in a screen 304. Such movement of the camera's field of view may be accomplished via the user manually moving the camera. (Alternatively, the camera's field of view does not actually move to the right but the camera automatically zooms in on the scene and the scene contents outside a certain area surrounding the object are omitted. In another alternative, zooming is automatically accomplished in the digital domain without changing the camera zoom by using an interpolation technique.) This operation may occur automatically in response to e.g. a touch within any area within the square 30 of screen 302, or via any other suitable input command pre-designated for this function. Referring to screen 304, when the capturing direction is moved, the object to be zoomed-in may be positioned at the middle of the zoom-in area. When a capturing direction of a camera is moved and thus an object to be zoomed-in is included in a zoom-in area, as shown in screen 306, the object is zoomed-in and captured (for example, a moving image of the object in the zoomed-in state is recorded). Note that the UI elements 20 and 30 may be automatically removed between screens 304 and 306. Further, the transition between screens 304 and 306 may occur automatically or in response to a user command.

Referring to FIG. 4, a currently captured image may be displayed on a display screen, as illustrated by screen 402. According to an embodiment, the display 170 may display a UI element (e.g., an outline of a box) 30 representing a zoom-in area according to a current capturing direction. A UI element 40 (e.g., a box the same size as box 30) may also be displayed representing an ideal (or specified) zoom-in area including an object to be zoomed-in. A user may change a capturing direction of the camera 110 via manual movement of device 100 to allow the UI element 30 representing a current zoom-in area to correspond to the UI element 40 representing an ideal zoom-in area. For example, if the two UI elements 30 and 40 representing a zoom-in area do not correspond to each other as shown in screen 402, a user may move a capturing direction of a camera to the right, resulting in a screen 404. As shown in screen 404, when the capturing direction is moved, the two UI elements 30 and 40 may correspond to each other. When the capturing direction is moved and the two UI elements 30 and 40 correspond to each other, an object is zoomed-in and captured as shown in screen 406.

Accordingly, as illustrated by FIGS. 3 and 4, a user may move a capturing direction of a camera conveniently and accurately by using the UI elements 20, 30, or 40 displayed on a display screen as guides. The movement may allow a user to easily focus in on an object from which sound is originating, or from a selected object from which the loudest sound is originating.

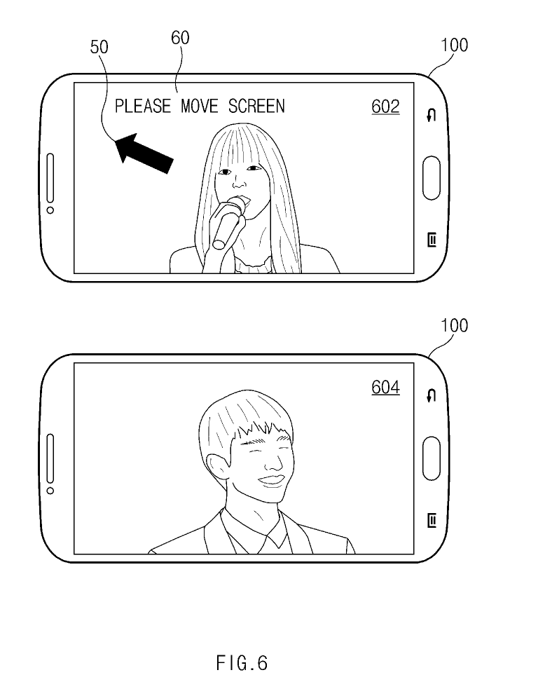

According to an embodiment, the display 170 may display a UI element (for example, an arrow) representing a movement direction of a camera or a text prompting a capturing direction to be changed, for example, “move capturing direction of camera to right”. This is illustrated below in reference to FIG. 6.

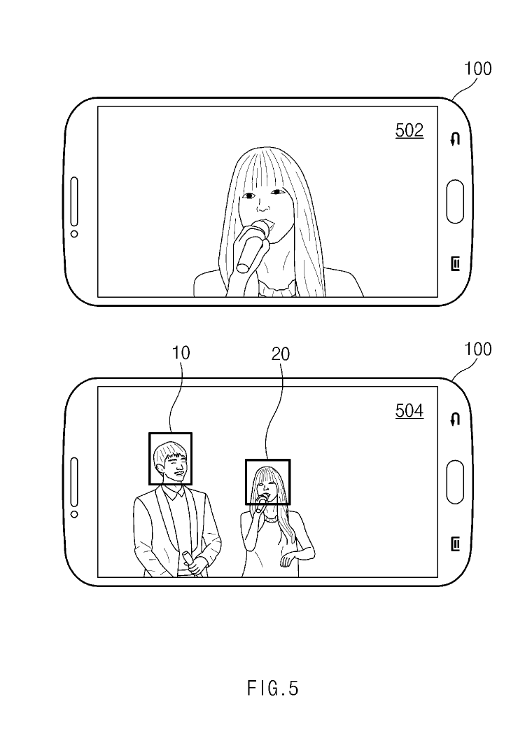

According to an embodiment, the capturing unit 110 may zoom-out and capture an image when it is determined that the originating position of an audio signal having the largest signal level among classified audio signals is out of a current capturing range. For example, the control unit 195 may make this determination and control the capturing unit 110 to perform a zoom-out operation to capture an object generating an audio signal. This will be described with reference to FIG. 5.

FIG. 5 is a view illustrating a contents recording screen according to various embodiments of the present invention. Screen 502a represents a display screen where a woman's face (that is, a second object) among objects shown in FIG. 2 is zoomed-in and captured. In this case, as the woman's face is zoomed-in and captured, a man's face may be positioned out of a capturing range. In a situation like this, when the woman's song part ends and the man's song part starts, an audio signal having the largest signal level may be generated out of the current capturing range (since a zoom-in state on the woman still occurs). The capturing unit 110 may then zoom-out and capture an image when it is determined that the originating position of an audio signal having the largest signal level among classified audio signals is out of a capturing range. Accordingly, as shown in screen 504, the man's face within UI element 10 and the woman's face within UI element 20 may be captured simultaneously as a result of the zoom-out.

According to an embodiment of the present invention, after zoom-out, as described with reference to FIG. 3 or 4, the object from which the loudest sound originates (in this example, the man's face, that is, a first object) may be zoomed-in and captured.

According to an embodiment, the display 170 may display a UI prompting the originating position of an audio signal to be captured when it is determined that the originating position of an audio signal having the largest signal level among classified audio signals is out of a capturing range. For example, when it is determined that the originating position of the audio signal is out of the capturing range, the display 170 may display a UI element representing the originating position of the audio signal. This will be described with reference to FIG. 6.

FIG. 6 is a view illustrating a contents recording screen according to various embodiments of the present invention. Screen 602 represents a display screen where a woman's face (that is, a second object) among objects shown in FIG. 2 is zoomed-in and captured. In this case, a man's face may be positioned out of a capturing range. In a situation as shown in screen 602, when woman's song part ends and man's song part starts, an audio signal having the largest signal level may be generated out of a capturing range. The display 170 may display a UI facilitating capture of the originating position of an audio signal to when it is determined that the originating position of an audio signal having the largest signal level among classified audio signals is out of a capturing range. For example, as shown in screen 602, the originating position (for example, the man's face) of an audio signal may be indicated by an arrow 50. As another example, a text UI prompting manual movement towards a capturing direction may be displayed, for example, “please move screen”. A user may change a capturing direction by referring to the UI displayed on the display 170 and manually moving the device 100 so as to capture the man's face as shown in screen 604.

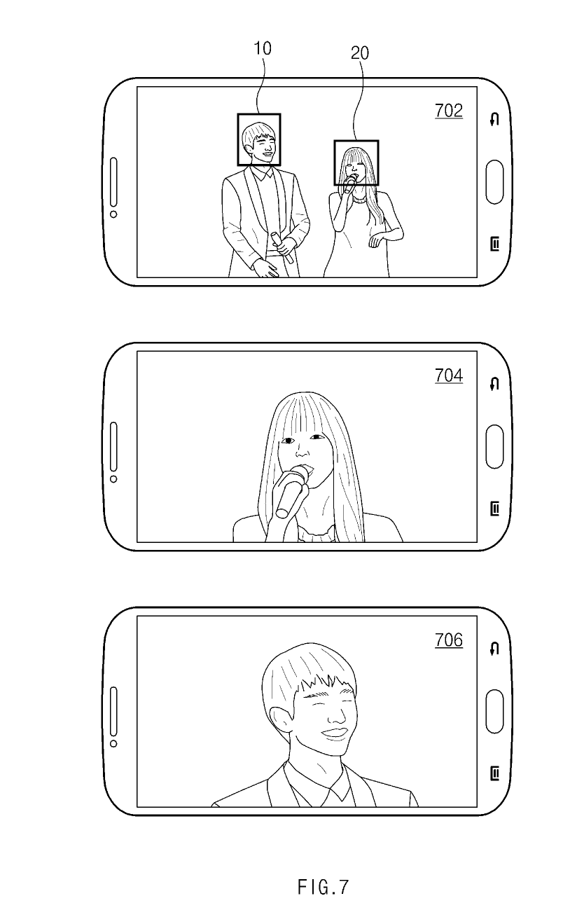

According to an embodiment of the present invention, while playing back recorded contents, the display 170 may enlarge and display an object mapped to an audio signal having the largest signal level among classified audio signals or an object selected by a user. This will be described with reference to FIG. 7.

FIG. 7 illustrates contents playback screens according to various embodiments of the present invention. When recorded contents are played back, an image in the contents may be displayed on a display screen as shown in screen 702. The display 170 may display a UI with a UI element 10 surrounding a first object and a second UI element 20 surrounding a second object included in the displayed image. UI elements 10 and 20 may be generated in response to a predetermined user input.

According to an embodiment, while playing back recorded contents, the display 170 may enlarge and display an object mapped to an audio signal having the largest signal level among classified audio signals. For example, when a woman sings a song in a playback screen as shown in screen 702, the woman's face (that is, a second object) may be enlarged and displayed as shown in screen 704. Then, while a man sings a song, the man's face (that is, a first object) may be enlarged and displayed as shown in screen 706.

According to an embodiment, the audio outputting unit 180 may output only an audio signal mapped to the enlarged and displayed object. For example, only an audio signal (for example, the woman's voice) mapped to the second object may be outputted in conjunction with the playback screen 704 which only depicts the woman. As another example, only an audio signal (for example, the man's voice) mapped to the first object may be outputted in conjunction with the playback screen 706 which only shows the man.

According to an embodiment, the display 170 may enlarge and display an object selected by a user. For example, when a user input for selecting the second object within box 20 is inputted on the playback screen as shown in screen 702, the second object may be enlarged and displayed as shown in screen 704. When a user input for selecting the first object within box 10 is inputted on the playback screen, the first object may be enlarged and displayed as shown in screen 706.

According to an embodiment, the audio outputting unit 180 may output only an audio signal mapped to an object selected by a user. For example, when a user instruction for selecting the second object within box 20 of screen 702 from the playback screen is inputted, only an audio signal (for example, the woman's voice) mapped to the second object may be outputted. Likewise, only the man's voice may be output when a user selection of box 10 is made.

An electronic device according to various embodiments of the present invention may include a capturing unit capturing an image, a mike unit collecting an audio signal corresponding to the captured image, an object detection unit detecting at least one object from the image, an audio analyzing unit classifying the audio signal according to an originating position, and a mapping unit mapping the classified audio signal into the detected object.

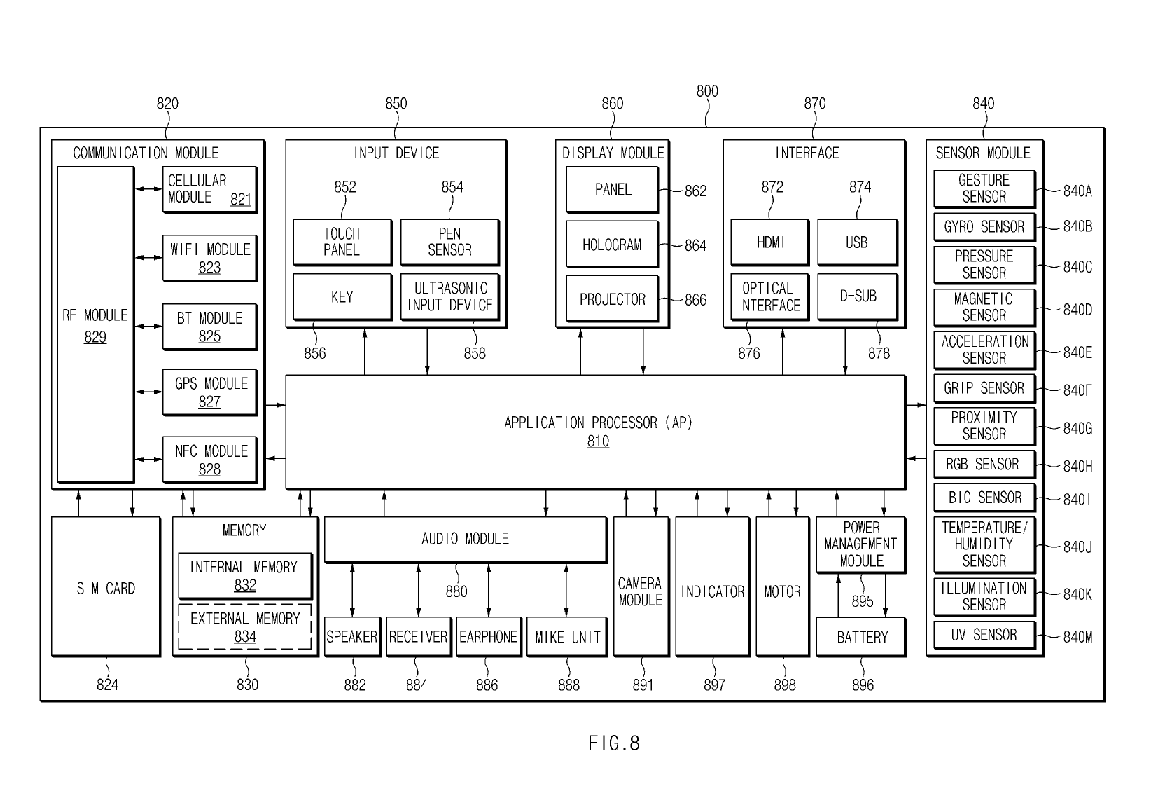

FIG. 8 is a block diagram illustrating example elements of an electronic device 800 according to various embodiments of the present invention. The electronic device 800, for example, may configure all or part of the above-mentioned electronic device 100 shown in FIG. 1. Electronic device 800 includes at least one application processor (AP) 810, a communication module 820, a subscriber identification module (SIM) card 824, a memory 830, a sensor module 840, an input device 850, a display 860, an interface 870, an audio module 880, a camera module 891, a power management module 895, a battery 896, an indicator 897, and a motor 898.

The AP 810 (for example, the control unit 195) may control a plurality of hardware or software components connected to the AP 810 and also may perform various data processing and operations with multimedia data by executing an operating system or an application program. The AP 810 may be implemented with a system on chip (SoC), for example. Processor 810 may further include a graphic processing unit (GPU) (not shown).

The communication module 820 may perform data transmission through a communication between other electronic devices connected to the electronic device 800 (for example, the electronic devices 100) via a network. Communication module 820 may include a cellular module 821, a Wifi module 823, a BT module 825, a GPS module 827, an NFC module 828, and a radio frequency (RF) module 829.

The cellular module 821 may provide voice calls, video calls, text services, or internet services through a communication network (for example, LTE, LTE-A, CDMA, WCDMA, UMTS, WiBro, or GSM). The cellular module 821 may perform a distinction and authentication operation on an electronic device in a communication network by using a subscriber identification module (for example, the SIM card 824), for example. According to an embodiment of the present invention, the cellular module 821 may perform at least part of a function that the AP 810 provides. For example, the cellular module 821 may perform at least part of a multimedia control function.

Cellular module 821 may further include a communication processor (CP). Additionally, the cellular module 821 may be implemented with SoC, for example. As shown in FIG. 8, components such as the cellular module 821 (for example, a CP), the memory 830, or the power management module 895 are separated from the AP 810, but the AP 810 may alternatively be implemented including some of the above-mentioned components (for example, the cellular module 821).

AP 810 or the cellular module 821 (for example, a CP) may load instructions or data, which are received from a nonvolatile memory or at least one of other components connected thereto, into a volatile memory and then may process them. Furthermore, the AP 810 or the cellular module 821 may store data received from or generated by at least one of other components in a nonvolatile memory.

Each of the Wifi module 823, the BT module 825, the GPS module 827, and the NFC module 828 may include a processor for processing data transmitted/received through a corresponding module. Although the cellular module 821, the Wifi module 823, the BT module 825, the GPS module 827, and the NFC module 828 are shown as separate blocks in FIG. 8, some (for example, at least two) of the cellular module 821, the Wifi module 823, the BT module 825, the GPS module 827, and the NFC module 828 may be alternatively included in one integrated chip (IC) or an IC package. For example, at least some (for example, a CP corresponding to the cellular module 821 and a Wifi processor corresponding to the Wifi module 823) of the cellular module 825, the Wifi module 827, the BT module 828, the GPS module 821, and the NFC module 823 may be implemented with one SoC.

The RF module 829 may be responsible for data transmission, for example, the transmission of an RF signal. Although not shown in the drawings, the RF module 829 may include a transceiver, a power amp module (PAM), a frequency filter, or a low noise amplifier (LNA). Additionally, the RF module 829 may further include components for transmitting/receiving electromagnetic waves on a free space in a wireless communication, for example, conductors or conducting wires. Although the cellular module 821, the Wifi module 823, the BT module 825, the GPS module 827, and the NFC module 828 share one RF module 829 shown in FIG. 8, at least one of the cellular module 821, the Wifi module 823, the BT module 825, the GPS module 827, and the NFC module 828 may alternatively perform the transmission of an RF signal through an additional RF module.

The SIM card 824 may be a card including a subscriber identification module and may be inserted into a slot formed at a specific position of an electronic device. The SIM card 824 may include unique identification information (for example, an integrated circuit card identifier (ICCID)) or subscriber information (for example, an international mobile subscriber identity (IMSI)).

The memory 830 (for example, the memory 160) may include an internal memory 832 or an external memory 834. The internal memory 832 may include at least one of a volatile memory (for example, dynamic RAM (DRAM), static RAM (SRAM), synchronous dynamic RAM (SDRAM)) and a non-volatile memory (for example, one time programmable ROM (OTPROM), programmable ROM (PROM), erasable and programmable ROM (EPROM), electrically erasable and programmable ROM (EEPROM), mask ROM, flash ROM, NAND flash memory, and NOR flash memory)

Internal memory 832 may be a Solid State Drive (SSD). The external memory 834 may further include flash drive, for example, compact flash (CF), secure digital (SD), micro secure digital (Micro-SD), mini secure digital (Mini-SD), extreme digital (xD), or memorystick. The external memory 834 may be functionally connected to the electronic device 800 through various interfaces. Electronic device 800 may further include a storage device (or a storage medium) such as a hard drive.

The sensor module 840 measures physical quantities or detects an operating state of the electronic device 800, thereby converting the measured or detected information into electrical signals. The sensor module 1840 may include at least one of a gesture sensor 840A, a gyro sensor 840B, a pressure sensor 840C, a magnetic sensor 840D, an acceleration sensor 840E, a grip sensor 840F, a proximity sensor 840G, a color sensor 840H (for example, a red, green, blue (RGB) sensor), a bio sensor 840I, a temperature/humidity sensor 840J, an illumination sensor 840K, and an ultra violet (UV) sensor 840M. Additionally/alternately, the sensor module 840 may include an E-nose sensor (not shown), an electromyography (EMG) sensor, an electroencephalogram (EEG) sensor (not shown), an electrocardiogram (ECG) sensor (not shown), an infra red (IR) sensor (not shown), an iris sensor (not shown), or a fingerprint sensor (not shown). The sensor module 840 may further include a control circuit for controlling at least one sensor therein.

The user input device 850 (for example, the input unit 190) may include a touch panel 852, a (digital) pen sensor 854, a key 856, or an ultrasonic input device 858. The touch panel 852 may recognize a touch input through at least one of capacitive, resistive, infrared, or ultrasonic methods, for example. Additionally, the touch panel 852 may further include a control circuit. In the case of the capacitive method, both direct touch and proximity recognition are possible. The touch panel 852 may further include a tactile layer. In this case, the touch panel 852 may provide a tactile response to a user.

The (digital) pen sensor 854 may be implemented through a method similar or identical to that of receiving a user's touch input or an additional sheet for recognition. The key 856 may include a physical button, a touch key, an optical key, or a keypad, for example. The ultrasonic input device 858, as a device checking data by detecting sound waves through a mike unit 888 (for example, the mike unit 120 of FIG. 1) in the electronic device 800, may provide wireless recognition through an input tool generating ultrasonic signals. According to an embodiment of the present invention, the electronic device 800 may receive a user input from an external device (for example, a computer or a server) connected to the electronic device 200 through the communication module 820.

The display 860 (for example, the display 170) may include a panel 862, a hologram device 864, or a projector 866. The panel 862, for example, may include a liquid-crystal display (LCD) or an active-matrix organic light-emitting diode (AM-OLED). The panel 862 may be implemented to be flexible, transparent, or wearable, for example. The panel 862 and the touch panel 852 may be configured with one module. The hologram 864 may show three-dimensional images in the air by using the interference of light. The projector 866 may display an image by projecting light on a screen. The screen, for example, may be placed inside or outside the electronic device 800. According to an embodiment of the present invention, the display 860 may further include a control circuit for controlling the panel 862, the hologram device 864, or the projector 866.

The interface 870 may include a high-definition multimedia interface (HDMI) 872, a universal serial bus (USB) 874, an optical interface 876, or a D-subminiature (sub) 878, for example. Additionally/alternately, the interface 870 may include a mobile high-definition link (MHL) interface, a secure Digital (SD) card/multi-media card (MMC) interface, or an infrared data association (IrDA) standard interface.

The audio module 880 may convert sound and electrical signals in both directions. The audio module 880 may process sound information inputted/outputted through a speaker 882, a receiver 884, an earphone 886, or a mike unit 888 (for example, the mike unit 120).

The camera module 891 (for example, the capturing unit 110), as a device for capturing a still image and a video, may include at least one image sensor (for example, a front sensor or a rear sensor), a lens (not shown), an image signal processor (ISP) (not shown), or a flash (not shown) (for example, an LED or a xenon lamp).

The power management module 895 may manage the power of the electronic device 800. Although not shown in the drawings, the power management module 895 may include a power management integrated circuit (PMIC), a charger integrated circuit (IC), or a battery or fuel gauge, for example.

The PMIC may be built in an IC or SoC semiconductor, for example. A charging method may be classified as a wired method and a wireless method. The charger IC may charge a battery and may prevent overvoltage or overcurrent flow from a charger. According to an embodiment of the present invention, the charger IC may include a charger IC for at least one of a wired charging method and a wireless charging method. As the wireless charging method, for example, there is a magnetic resonance method, a magnetic induction method, or an electromagnetic method. An additional circuit for wireless charging, for example, a circuit such as a coil loop, a resonant circuit, or a rectifier circuit, may be added.

The battery gauge may measure the remaining amount of the battery 896, or a voltage, current, or temperature of the battery 396 during charging. The battery 896 may store or generate electricity and may supply power to the electronic device 800 by using the stored or generated electricity. The battery 896, for example, may include a rechargeable battery or a solar battery.

The indicator 897 may display a specific state of the electronic device 800 or part thereof (for example, the AP 810), for example, a booting state, a message state, or a charging state. The motor 898 may convert electrical signals into mechanical vibration. Although not shown in the drawings, the electronic device 800 may include a processing device (for example, a GPU) for mobile TV support. A processing device for mobile TV support may process media data according to the standards such as digital multimedia broadcasting (DMB), digital video broadcasting (DVB), or media flow.

Each of the above-mentioned components of the electronic device according to various embodiments of the present invention may be configured with at least one component and the name of a corresponding component may vary according to the kind of an electronic device. An electronic device according to an embodiment of the present invention may be configured including at least one of the above-mentioned components or additional other components. Additionally, some of components in an electronic device according to an embodiment of the present invention are configured as one entity, so that functions of previous corresponding components are performed identically.

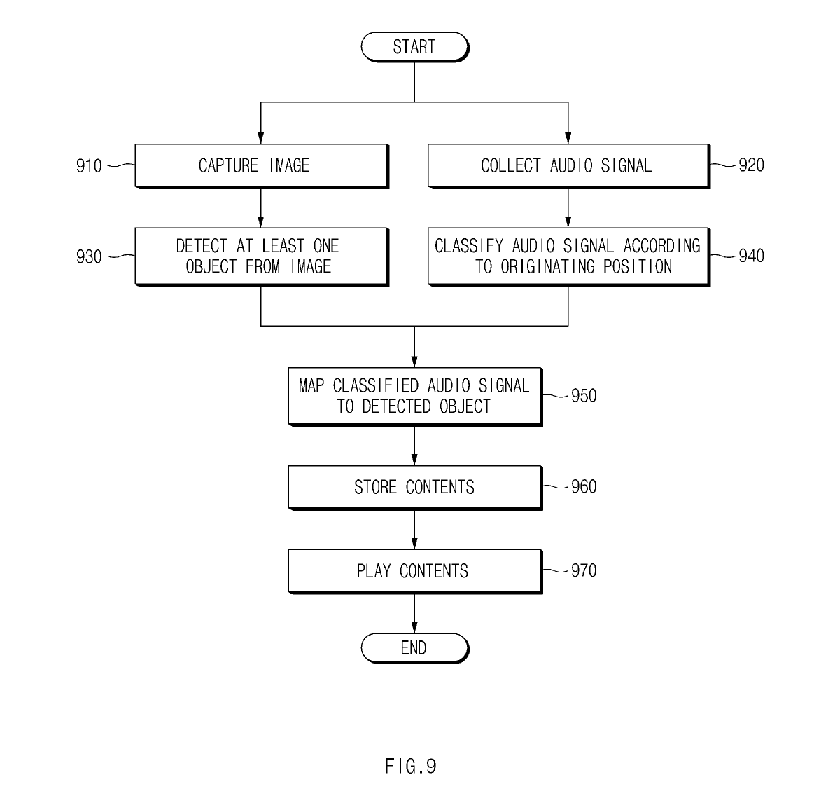

FIG. 9 is a flowchart illustrating a recording method of an electronic device according to an embodiment of the present invention.

The flowchart shown in FIG. 9 may be configured with operations processed in the electronic device shown in FIG. 1 or FIG. 8. Accordingly, even omitted contents, which are described for the electronic device shown in FIG. 1 or 8, may be applied to the flowchart of FIG. 9.

Referring to FIG. 9, the electronic device 100 may capture an image in operation 910. According to an embodiment of the present invention, the electronic device 100 may capture images continuously on a frame by frame basis, thereby capturing a moving image, and may then generate and record a video clip.

According to an embodiment of the present invention, the electronic device 100 may capture images by using a plurality of cameras. For example, when the electronic device 100 is implemented with a smartphone, it may include two cameras positioned at the front of the smartphone and two cameras positioned at the rear of the smartphone. An image captured by a first one of the cameras may differ from an image captured by a second one of the cameras due to a visual point difference of a capturing lens.

According to an embodiment of the present invention, the electronic device 100 may focus or zoom-in an object detected in operation 930. For example, the electronic device 100 may capture an image by automatically focusing or zooming-in an object mapped to a signal having the highest signal level among classified audio signals. As another example, the electronic device 100 may capture an image by automatically focusing or zooming-in an object mapped to a signal having the largest change in signal level among classified audio signals. As another example, the electronic device 100 may focus or zoom-in an object selected by a user among detected objects.

According to an embodiment, the electronic device 100 may zoom-out and capture an image when it is determined that the originating position of an audio signal having the highest signal level among audio signals classified in operation 940 is out of a capturing range.

According to an embodiment, the electronic device 100 may display images captured in operation 910. According to an embodiment of the present invention, as displaying a captured image, the electronic device 100 may display a user interface (UI) representing an object included in the captured image.

According to an embodiment, the electronic device 100 may display a UI prompting a user to position a zoomed-in object in a zoom-in area. According to an embodiment of the present invention, the electronic device 100 may display a UI inducing the originating position of an audio signal to be captured when it is determined that the originating position of an audio signal having the largest signal level among audio signals classified in operation 940 is out of a capturing range.

In operation 920, the electronic device 100 may collect an audio signal. Electronic device 100 may convert a sound occurring from surroundings into electrical signals by using a mike unit to generate an audio signal. Device 100 may collect an audio signal corresponding to a captured image. For example, the electronic device 100 may capture an image and collect an audio signal simultaneously in operation 910. Electronic device 100 may collect an audio signal by using a plurality of mikes of mike unit 120. (In this case, each audio signal captured by one of the mikes may be considered an audio signal portion of the audio signal. Stated another way, it may be considered that each of the plurality of mikes collects an individual audio signal, such that mike unit collects a plurality of audio signals. Such collection/detection of audio by the microphone array enables a derivation of the originating position of the audio via comparison of the audio signals or audio signal portions.)

In operation 930, the electronic device 100 may detect an object from the captured image. The object may be a specific portion included in an image, for example, a face and a thing included in the captured image. For example, the object may be a person's face, an animal, or a vehicle. According to an embodiment, the electronic device 100 may determine the position (for example, a direction or a distance) of an included object.

In operation 940, the electronic device 100 may classify a collected audio signal. According to an embodiment of the present invention, the electronic device 100 may determine the direction or distance of an audio signal by analyzing audio signals collected by a microphone array of the mike unit 120. According to an embodiment of the present invention, an electronic device may classify an audio signal on the basis of an analysis result of audio signals. For example, the audio analyzing unit 140 may classify an audio signal according to the originating position (for example, a direction or a distance).

In operation 950, the electronic device 100 may map an audio signal into an object. According to an embodiment of the present invention, the electronic device 100 may map an audio signal to an object on the basis of the position of an object and the originating position of a classified audio signal. For example, the electronic device 100 may map an audio signal to an object positioned in the same direction as the originating position of the audio signal.

According to an embodiment of the present invention, the electronic device 100 may map an audio signal to an object on the basis of a position change of an object or an audio signal. For example, when there are a plurality of objects at the originating position of an audio signal, the electronic device 100 may map an object (of which position (direction or distance) change is identical to an originating position (direction or distance) change of an audio signal) among the plurality of objects into the audio signal.

According to an embodiment of the present invention, the electronic device 100 may generate mapping information of an object and a classified audio signal.

In operation 960, the electronic device 100 may store contents. According to an embodiment of the present invention, the contents may include captured images, classified audio signals, and mapping information of objects and classified audio signals. According to an embodiment of the present invention, the contents may include information on objects included in an image or information on classified audio signals.

In operation 970, the electronic device 100 may play contents. According to an embodiment of the present invention, the electronic device 100 may play contents to display an image and output an audio signal.

According to an embodiment, while playing contents, the electronic device 100 may enlarge and display an object mapped to an audio signal having the largest signal level among classified audio signals or an object selected by a user.

According to an embodiment, while playing contents, the electronic device 100 may output at least part of classified audio signals in a level different from a level of an existing audio signal. According to an embodiment of the present invention, while playing back recorded contents, the electronic device 100 may output an audio signal mapped to an object selected by a user or an object enlarged and displayed on a display screen among classified audio signals.

A recording method of an electronic device according to various embodiments of the present invention may include capturing an image, collecting an audio signal corresponding to the captured image, detecting at least one object from the image, classifying the audio signal according to an originating position, and mapping the classified audio signal to the detected object.

The recording method of the electronic device according to the above-mentioned various embodiments of the present invention may be implemented with a program executable in the electronic device. Then, such a program may be stored in various types of recording media and used.

In more detail, program codes for performing the above methods may be stored in various types of nonvolatile recording media, for example, flash memory, read only memory (ROM), erasable programmable ROM (EPROM), electronically erasable and programmable ROM (EEPROM), hard disk, removable disk, memory card, USB memory, and CD-ROM.

According to various embodiments of the present invention, video contents may be recorded or played in dynamic and various manners. Additionally, when contents are recorded, without a user's input, focus or zoom-in/zoom-out may be automatically performed on the basis of a capturing environment, so that user convenience may be increased.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the appended claims.

What is claimed is:

1. An electronic device comprising:
a capturing unit configured to capture an image;
a mike unit configured to receive an audio signal while the image is captured;
an object detection unit configured to detect one or more objects from the image;
an audio analyzing unit configured to determine an originating position of the audio signal received by the mike unit; and
a mapping unit configured to map the audio signal to a detected object of the one or more objects that corresponds to the determined originating position.

2. The electronic device according to claim 1, wherein the mike unit comprises a plurality of mikes.

3. The electronic device according to claim 1, wherein the capturing unit focuses or zooms-in an object mapped to an audio signal having the highest level among audio signals received by the mike unit, or an object selected by a user.

4. The electronic device according to claim 3, further comprising a display configured to display a user interface (UI) that prompts a user action to position the zoomed-in object in a zoom-in area of the display.

5. The electronic device according to claim 1, wherein when it is determined that the originating position of an audio signal having the highest level among received audio signals is out of a capturing range, the capturing unit performs a zoom-out operation and captures an object corresponding to the originating position.

6. The electronic device according to claim 1, further comprising a display, and wherein when it is determined that the originating position of an audio signal having the highest level among classified audio signals is outside a capturing range, a UI is displayed that prompts a user action enabling image capture of an object corresponding to the originating position.

7. The electronic device according to claim 1, further comprising a memory configured to store contents including at least one among the captured image, classified audio signals received by the mike unit, and mapping information of objects to the classified audio signals.

8. The electronic device according to claim 7, further comprising at least one of a display or an audio outputting unit supporting the playback of the stored contents.

9. The electronic device according to claim 8, wherein the display enlarges and displays an object mapped to an audio signal having the highest level among classified audio signals or an object selected by a user.

10. The electronic device according to claim 8, wherein the audio outputting unit outputs at least some of the classified audio signals at a level different from a level of an original audio signal.

11. The electronic device according to claim 8, wherein the audio outputting unit outputs only an audio signal mapped into an object selected by a user or an object enlarged and displayed on a display among the classified audio signals.

12. A method of an electronic device, the method comprising:
capturing an image;
receiving an audio signal while the image is captured;
detecting at least one object from the image;
determining an originating position of the audio signal; and
mapping the audio signal to an object corresponding to the originating position.

13. The method according to claim 12, wherein the audio signal is received by a plurality of mikes of the electronic device, and the originating position is determined on the basis of output signals of the plurality of mikes.

14. The method according to claim 12, further comprising focusing or zooming-in an object mapped to an audio signal having the highest level among classified audio signals or an object selected by a user.

15. The method according to claim 14, further comprising displaying a user interface (UI) prompting a user to position the zoomed-in object in a zoom-in area.

16. The method according to claim 12, wherein the capturing of an image further comprises, when it is determined that an originating position of an audio signal having the highest level among classified audio signals is out of a capturing range, performing a zoom-out operation and capturing an object corresponding to the originating position of the audio signal having the highest level.

17. The method according to claim 12, further comprising, when it is determined that the originating position of an audio signal having the highest level among the classified audio signals is output a capturing range, displaying a user interface (UI) prompting a user action to image capture an object corresponding to an originating position of the audio signal having the highest level.

18. The method according to claim 12, further comprising storing in a memory contents including at least one among the captured image, classified audio signals, and mapping information of the object and the classified audio signals.

19. The method according to claim 18, further comprising playing the stored contents.

20. The method according to claim 19, wherein the playing of the stored contents comprises enlarging and displaying an object mapped to an audio signal having the highest level among classified audio signals or an object selected by a user.

21. The method according to claim 19, wherein the playing of the stored contents comprises outputting at least some of the classified audio signals at a level different from a level of an original audio signal.

22. The method according to claim 19, wherein the playing of the stored contents comprises outputting only an audio signal mapped to an object selected by a user or an object enlarged and displayed on a display among the classified audio signals.

23. A non-transitory computer readable recording medium having stored therein instructions, which when executed by a computing device, perform the method of claim 12.
